(19) United States
(12) Patent Application Publication
(10) Pub. No.: US 2010/0106402 A1
(43) Pub. Date: Apr. 29, 2010

(54) MOBILE NAVIGATION METHOD AND DEVICE FOR ROUTE PLANNING

(75) Inventor: XianZhong Liu, Shanghai City (CN)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: INVENTEC CORPORATION, Taipei County (TW)

(21) Appl. No.: 12/606,716

(22) Filed: Oct. 27, 2009

(30) Foreign Application Priority Data
Oct. 28, 2008 (TW) 097141348

(51) Int. Cl. G01C 21/36; H04W 24/00

(52) U.S. Cl. 701/201; 455/456.1

(57) ABSTRACT

A mobile navigation method and device of route planning are provided. The method and the device enable a user to drive on a backup vehicle driving route in advance when discovering a congestion-prone road section is in poor condition. The method includes the following steps. Firstly, it is determined whether the main vehicle driving route includes at least one congestion-prone road section or not. If the main vehicle driving route includes at least one congestion-prone road section, a backup vehicle driving route is planned in a road section ahead of the congestion-prone road section. Then, it is determined whether the backup vehicle driving route is substituted for the main vehicle driving route according to an actual obtained traffic condition of the congestion-prone road section.

### CROSS-REFERENCE TO RELATED APPLICATION

This application claims the benefit of Taiwan Patent Application No. 097141348, filed on Oct. 28, 2008, which is hereby incorporated by reference for all purposes as if fully set forth herein.

### BACKGROUND OF THE INVENTION

1. Field of Invention

The present invention relates to a mobile navigation method and device for route planning, and more particularly to a method for backup route planning applied to a mobile device using a Global Positioning System (GPS) navigation program and a device using the same.

2. Related Art

The Global Positioning System (GPS) is a navigation system that integrates satellites and wireless technology, which can provide users with precise position, speed and time information. Currently, the GPS has been widely applied in the market. With the advancement in the satellite technology, many GPS technologies and business opportunities are developing rapidly. At first, the application of the GPS was only limited to military units for military purposes, e.g. precise positioning of battle planes, ships, vehicles, personnel, targets of attacking etc. Currently, the GPS has been opened to civilian for the positioning. The technology which integrates space satellites and communication technology has developed widely in the civilian market. The GPS navigation and positioning brings about revolutionary changes in life applications, for example, moving vehicles and ships can decide precisely the destination arrival time and path through the GPS, an ambulance can effectively perform the rescue in an emergency, and a car driver can be aware of the current location and the path to a destination through an electronic map.

However, in actual driving, the traffic condition often affects the destination arrival time, for example, road congestions, which can be substantially classified into expectable and unpredictable congestions. The expectable congestions are congestions which tend to occur in specific places seasonally, such as on main roads in rush hour, specific sections on highways, or roads near schools in the school run; the totally unpredictable congestions are congestions, for example, resulted from traffic accidents.

It should be noted that if these roads are not differentiated from others, when a user driving on a route originally planned, the user may ignore other available routes but only stay on the route originally planned, as a sudden change of the route may result in accidents. Thus, the time of the user is wasted, and the strength and energy of the user is exhausted.

### SUMMARY OF THE INVENTION

Accordingly, the invention is directed to a mobile navigation method, which is applied to a mobile device using a Global Positioning System (GPS) navigation program, and provides a substitute route for congestion-prone road sections in advance when planning a route for driving.

The present invention provides a mobile navigation method. In the mobile navigation method, a mobile device receives a setting of a destination, and plans a main vehicle driving route according to a position of the set destination, in which the main vehicle driving route includes a plurality of road sections.

Firstly, it is determined if the plurality of road sections of the main vehicle driving route includes at least one congestion-prone road section, in which the congestion-prone road section is obtained from designating by a user or comparing with a database of congestion-prone road sections preset in the mobile device. Secondly, when the congestion-prone road section exists in the main vehicle driving route, a backup vehicle driving route as a substitute is planned according to the congestion-prone road section. In detail, the method includes planning the backup vehicle driving route corresponding to the destination set by the user at a road section ahead of congestion-prone road section in order to avoid driving on the congestion-prone road section.

Furthermore, when the user drives to a place ahead of the congestion-prone road section and the congestion-prone road section is in poor condition, the user decides whether or not to drive on the backup vehicle driving route instead of the main vehicle driving route to the destination the user intends to arrive at according to an actual obtained traffic condition of the congestion-prone road section. The actual obtained traffic condition of the congestion-prone road section is obtained according to a broadcast signal received by a Traffic Message Channel (TMC) receiving module or a mobile communication signal received by a radio frequency (RF) signal receiving module on the mobile device.

The invention relates also provides a mobile navigation device, which includes a GPS module, and is used to plan a main vehicle driving route including a plurality of road sections according to a destination. The mobile navigation device includes a storage module for storing information about congestion-prone road sections, a determining unit for determining whether or not the main vehicle driving route includes at least one of the congestion-prone road sections stored in the storage module, a receiving module for receiving a broadcast message by using a TMC or RF signal and obtaining information about an actually congested road section, and a route generator for generating a backup vehicle driving route when the main vehicle driving route includes the congestion-prone road section stored in the storage module and substituting the backup vehicle driving route for the main vehicle driving route when the actually congested road section obtained by the receiving module is consistent with the congestion-prone road section.

As described above, the present invention provides a mobile navigation method which, according to each road section which tends to be in poor traffic condition, plans a plurality of backup vehicle driving routes for substituting for the road section, and obtains the congestion message before driving to the road section in a poor traffic condition in advance. Thus, a user can switch the vehicle driving route to the backup vehicle driving route, such that the user will not be trapped in the congestion-prone road section when driving, thereby reducing the time to drive to the destination effectively.

### BRIEF DESCRIPTION OF THE DRAWINGS

The present invention will become more fully understood from the detailed description given herein below for illustration only, and thus are not limitative of the present invention, and wherein:

FIG. 1 is a schematic flow chart of a mobile navigation method according to an embodiment of the present invention;

FIG. 2A is a schematic view of a user interface displaying a main vehicle driving route according to an embodiment of the present invention;

FIG. 2B is a schematic view of a user interface displaying a main vehicle driving route and all of the backup vehicle driving routes according to an embodiment of the present invention;

FIG. 2C is a schematic diagram of a user interface displaying a first backup vehicle driving route according to an embodiment of the present invention;

FIG. 2D is a schematic diagram of a user interface displaying a second backup vehicle driving route according to an embodiment of the present invention; and

FIG. 3 is a system block diagram of a mobile navigation device according to an embodiment of the present invention.

### DETAILED DESCRIPTION OF THE INVENTION

To make the present invention more comprehensible, the present invention is described in detail in the following with reference to the embodiments and accompanying drawings.

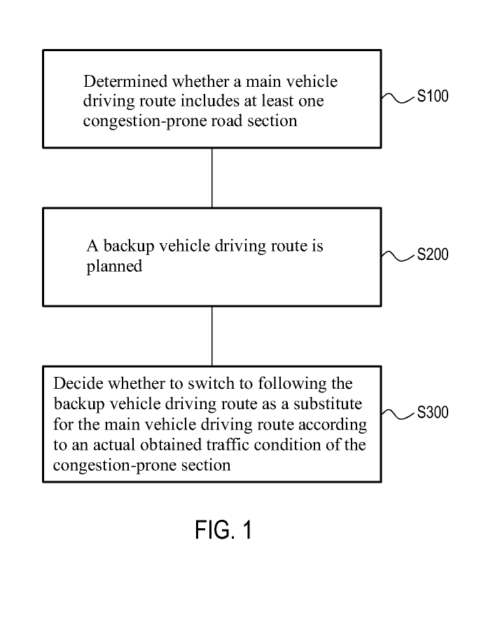

FIG. 1 is a schematic flow chart of a navigation method for route planning according to an embodiment of the present invention. Referring to FIG. 1, the method includes the following steps.

It is determined whether or not a main vehicle driving route includes at least one congestion-prone road section (step S100). A mobile device using a Global Positioning System (GPS) navigation program is used to receive a position of a destination that a user of the mobile device intends to arrive at, and to plan a vehicle driving route according to the set destination. Here, a main vehicle driving route is planned by combining a plurality of road sections. Then, it is determined whether the main vehicle driving route includes at least one congestion-prone road section or not. Furthermore, the congestion-prone road section is obtained according to the congestion-prone road section happens a poor traffic condition set by the user of the mobile device or matching one of the plurality of road sections in a database of the congestion-prone road sections preset on the mobile device.

A backup vehicle driving route is planned (step S200). When it is determined that there is a congestion-prone road section which tends to be in a poor traffic condition in the main driving road section, a backup vehicle driving route is planned on a road section leading to the congestion-prone road section, as a substitute of the main vehicle driving route according to the congestion-prone road section. In detail, on a road section leading to the congestion-prone road section, there will be another backup road section for bypassing the congestion-prone road section to arrive at the destination. Thus, the user can avoid the congestion-prone road section.

According to the actual obtained traffic condition of the congestion-prone road section, it is decided whether to switch to follow the backup vehicle driving route as a substitute for the main vehicle driving route (step S300). Then, it is determined whether to change to the backup vehicle driving route to the destination based on the actual traffic obtained conditions of the congestion-prone road section. For example, when driving on the main vehicle driving route, it is inquired whether or not a road section is in the poor traffic condition in advance according to a broadcast signal through a Traffic Message Channel (TMC) receiving module or a mobile communication signal through a radio frequency (RF) signal receiving module on the mobile device, thereby deciding whether or not to switch to drive on the backup vehicle driving route as a substitute of the original main vehicle driving route before leading to the congestion-prone road section, such that the user can arrive at the destination in time. Here, the situations prone to congestion include incidental situations such as traffic congestions and traffic accidents.

Furthermore, the GPS navigation program is required to use the mobile device of the present invention, and the mobile device includes a mobile device such as a mobile phone, a personal digital assistant (PDA), a personal digital assistant phone (PDA Phone), a smart phone, or a navigator.

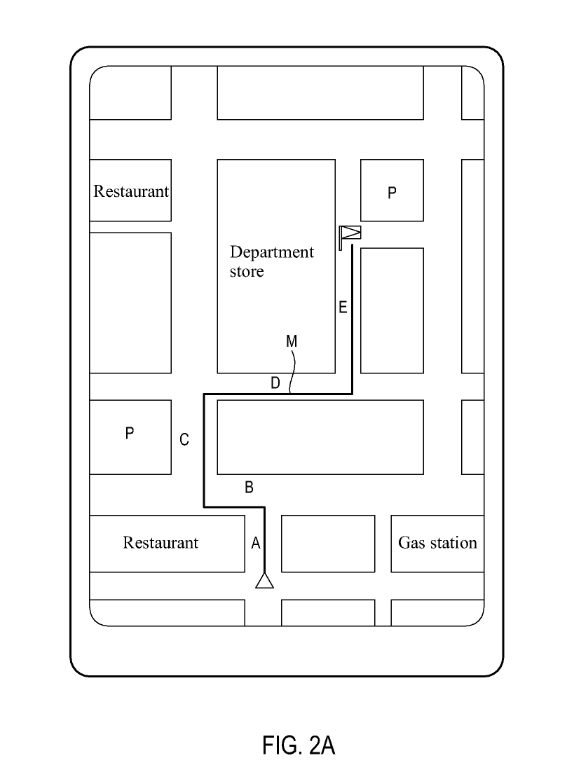

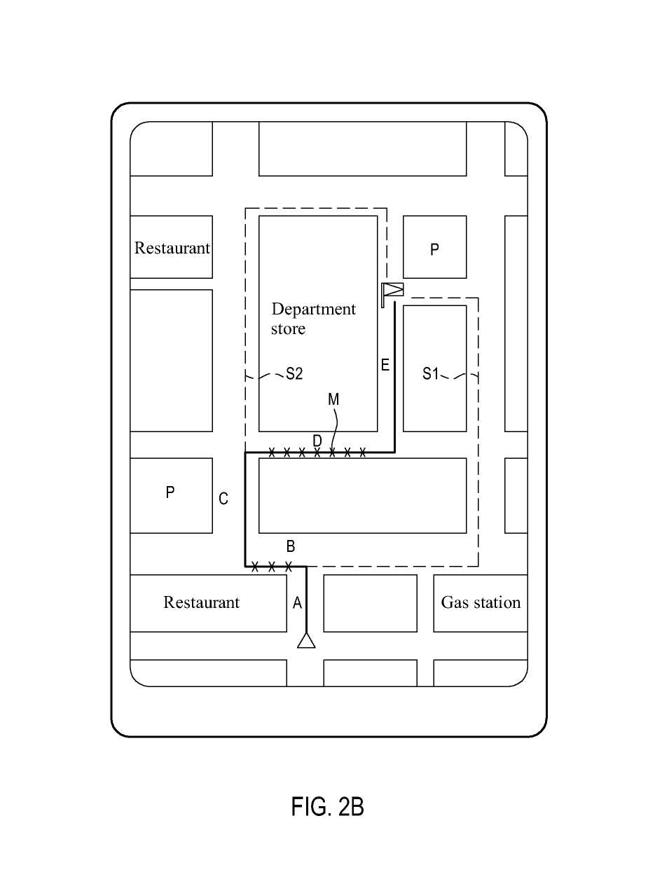

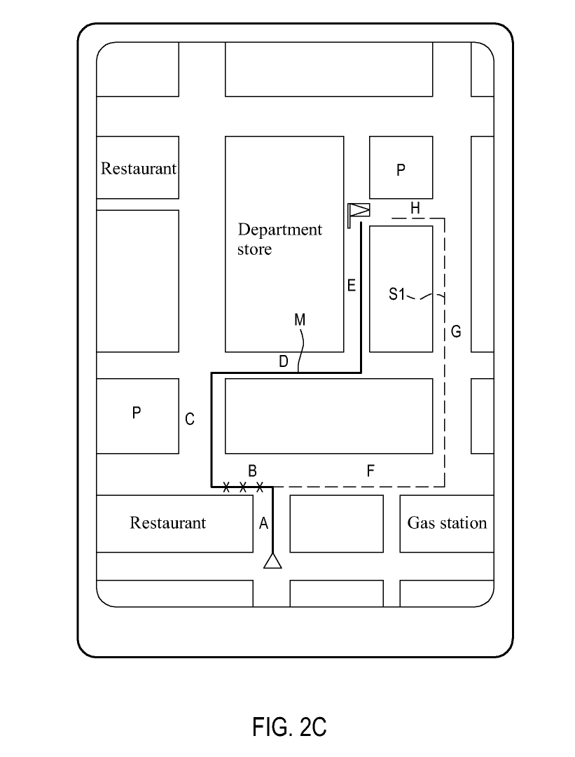

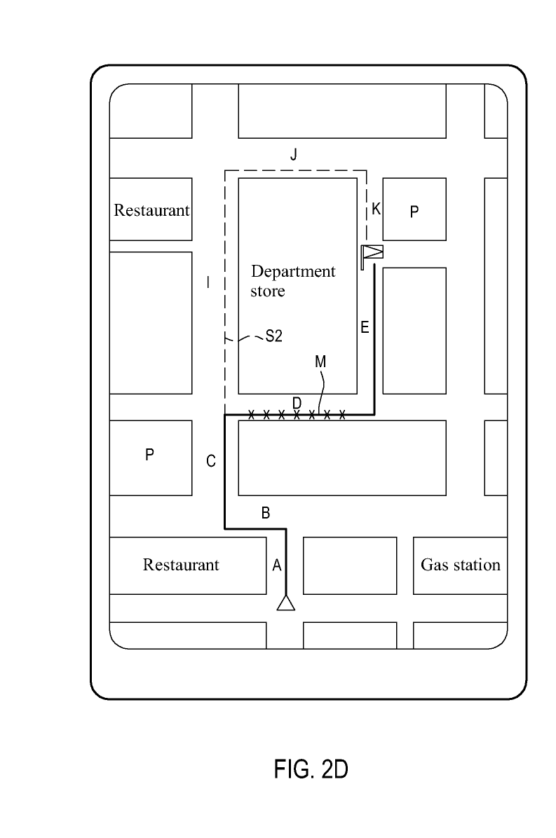

FIGS. 2A to 2D are schematic views of a user interface applied to the mobile navigation method for route planning according to an embodiment of the present invention, in which FIG. 2B shows a main vehicle driving route and all the backup vehicle driving routes, FIG. 2C shows a first backup vehicle driving route, and FIG. 2D shows a second backup vehicle driving route. All the backup vehicle driving routes are applied to the mobile device having a GPS navigation program.

After the mobile device receives the destination set by the user, in this embodiment, a plurality of road sections is used to plan a main vehicle driving route M for the user to drive from a start position to the destination at first. For example, as shown in FIG. 2A, after a destination setting is received, a main vehicle driving route M is planned according to the destination, and the main vehicle driving route M includes road sections A, B, C, D and E, that is, the user can drive from the road section A to the road section E to arrive at the destination.

Furthermore, after the main vehicle driving route M is planned, it is determined whether or not the main vehicle driving route M includes at least one congestion-prone road section. It should be noted that, if the determination is that a congestion-prone road section exists in the main vehicle driving route M, the present invention will plan each corresponding backup vehicle driving route according to a road section ahead of each congestion-prone road section in the main vehicle driving route M. Here, the congestion-prone road sections are designated by the user of the mobile device or are determined by matching one of the plurality of road sections in a database of the congestion-prone road sections preset in the mobile device.

That is, when the main vehicle driving route M is planned, the substitute backup vehicle driving route is planned according to the congestion-prone road section at the same time, which is different from the conventional art in which only the main route is planned, and the substitute route is planned only when the user drives out of the main route.

For example, in FIG. 2B, it is known that the congestion-prone road sections in the main vehicle driving route M are road sections B and D respectively. Therefore, when the main vehicle driving route M is planned, the backup vehicle driving routes for the user to drive on are planned respectively on a road section leading to the congestion-prone road sections B and D respectively, such that the user can avoid the congestion-prone road sections, and the time originally spent on arriving at the destination is reduced effectively.

In detail, in FIG. 2C, in order to avoid the road section B prone to congestion, a vehicle driving route is provided for the user to drive conveniently. Further, a first backup vehicle driving route S1 corresponding to the road section B which tends to be in the poor traffic condition will be planned. However, the road section B is the place where the congestion occurs, so the backup vehicle driving route is planned the road section A ahead of the road section B, and the first backup vehicle driving route S1 includes road sections A, F, G, and H.

Notably, in FIG. 2D, a second backup vehicle driving route S2 is planned for the road section D prone to congestion, such that the user can avoid the road section D prone to congestion, especially when the user discovers that the congestion-prone road section B is not blocked, and can be passed through in the actual traffic. Therefore, the second backup vehicle driving route S2 corresponding to the congestion-prone road section D is further planned. Thus, the problem that the user cannot arrive at the destination because the user drives to the road section D is prevented, and the scheduled driving time will not be extended because of the traffic congestion. However, the planning of the second backup vehicle driving route S2 is to avoid the congestion-prone road section D on purpose, and switch to drive to the destination of the user through the road sections A, B, C, I, J and K.

Further, the present invention may determine the actual condition of the congestion-prone road section such as the road section which tends to have traffic congestion and traffic accidents according to the broadcast signal through a TMC receiving module or the mobile communication signals through a RF signal receiving module on the mobile device, and decide whether to use the backup vehicle driving routes instead of the main vehicle driving route M. Here, the backup vehicle driving route includes the first backup vehicle driving route S1 and the second backup vehicle driving route S2.

That is to say, when driving in the main vehicle driving route M, and knowing the incidental situations such as traffic congestions and traffic accidents in the congestion-prone road sections before driving to the pre-estimated congestion-prone road sections, the user may switch to following the backup vehicle driving routes instead of the main vehicle driving route M immediately without having to stop for resetting and navigation.

Therefore, in FIG. 2C, when driving to the road section B in the poor traffic condition, the user may decide whether to switch to the first backup vehicle driving route S1 immediately according to the actual traffic condition, that is, to arrive at the destination set by the user of the mobile device through the road sections F, G and H. In detail, when the actual traffic condition of the road section B is congested as shown in the figure, the first backup vehicle driving route S1 is used instead of the main vehicle driving route M.

In another aspect, as shown in FIG. 2D, when driving in the main vehicle driving route M, if the user discovers that the road section B prone to congestion may be passed through, and finds that the road section D is in the poor traffic condition before driving into the congestion-prone road section D, the user may switch the vehicle driving route immediately to drive on the second backup vehicle driving route S2, switch to drive to the road section J from the road section I, and drive to the road section K from the road section J, so as to arrive at the set destination of the user.

Notably, when the user decided to drive on the backup vehicle driving route, the backup vehicle driving route is substituted for the main vehicle driving route M, and whether or not the backup vehicle driving route includes the congestion-prone road section is redetermined. When the backup vehicle driving route includes the congestion-prone road section, another one or more backup vehicle driving routes are planned additionally. Here, the backup vehicle driving routes include the first backup vehicle driving route S1 and the second backup vehicle driving route S2.

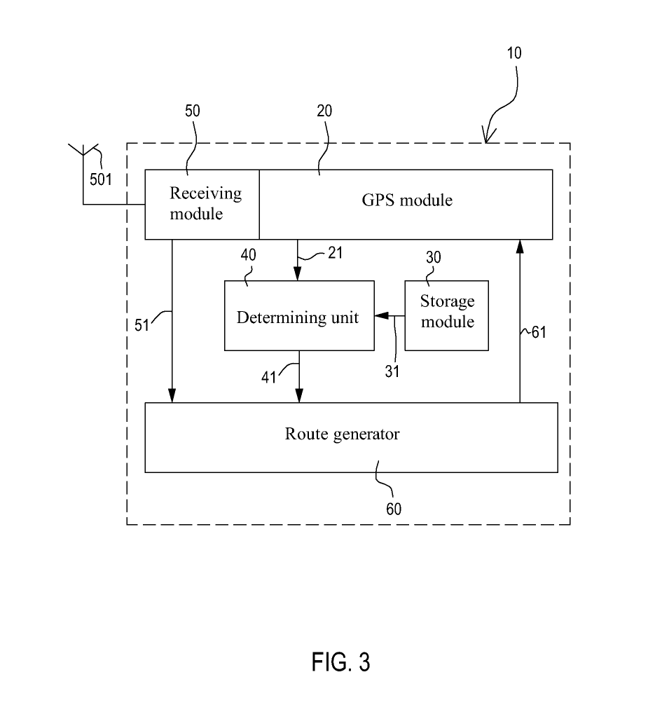

FIG. 3 is a system block diagram of the mobile navigation device according to an embodiment of the present invention. Referring to FIG. 3, the mobile navigation device 10 has a GPS module 20 for planning a main vehicle driving route including a plurality of road sections according to a destination. The mobile navigation device 10 includes a storage module 30, a determining unit 40, a receiving module 50, and a route generator 60. The storage module 30 stores information about at least one congestion-prone road section. The determining unit 40 is used to determine whether or not the main vehicle driving route includes the at least one congestion-prone road section whose information is stored in the storage module 30. The receiving module 50 includes an antenna, and obtains information about an actually congested road section according to a received broadcast message. The received broadcast message can be obtained by receiving a broadcast signal through a Traffic Message Channel (TMC) receiving module on the mobile device or obtained by receiving a mobile communication signal through a radio frequency (RF) receiving module on the mobile device.

The route generator 60 is used to generate a backup vehicle driving route. If it is determined that the main vehicle driving route includes the at least one congestion-prone road sections, and it is substituted the backup vehicle driving route for the main vehicle driving route if the actually congested road section matches the congestion-prone road section.

After the determining unit 40 matching information 21 about the main vehicle driving route message with information 31 about the congestion-prone road section, the backup vehicle driving route is generated by the route generator 60 for the congestion-prone road sections in the main vehicle driving route. It should be noted that the information 21 about an actually congested road section can further comprises the actual traffic condition of the actually congested road section. The actual traffic condition of the actually congested road section can be obtained by receiving a broadcast signal through a Traffic Message Channel (TMC) receiving module on the mobile device or obtained by receiving a mobile communication signal through a radio frequency (RF) receiving module on the mobile device.

When the receiving module 50 discovers that the actually congested road section is one of the congestion-prone road sections in the main vehicle driving route, the backup vehicle driving route is substituted for information 61 about the main vehicle driving route message 61. Or, when the receiving module 50 discovers that the information 21 about actual obtained traffic conditions of the congestion-prone road section matches one of the congestion-prone road sections in the main vehicle driving route, the backup vehicle driving route is used to substitute the main vehicle driving route. That is, whether the backup vehicle driving route is substituted for the main vehicle driving route depends on the actual traffic condition of the actually congested road section.

To sum up, according to the mobile navigation method and device for route planning of the present invention, a user may obtain the actual traffic condition of the road sections ahead in advance, does not need to pull up to reset the navigation route manually, and may avoid the congestion-prone road sections easily in driving in the case of the poor traffic condition such as traffic congestion and traffic accidents. Thus, the user can arrive at the destination in time, and much time and energy of the user may be saved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A mobile navigation method, applied to a mobile device using a Global Positioning System (GPS) navigation program, wherein the mobile device receives a destination, and is used to plan a main vehicle driving route according to the destination, and the main vehicle driving route comprises a plurality of road sections, and the mobile navigation method comprises:
determining whether the main vehicle driving route comprises at least one congestion-prone road section or not;
if the determination is that the main vehicle driving route comprises the at least one congestion-prone road section, planning a backup vehicle driving route on a road section leading to the congestion-prone road section for bypassing the congestion-prone road section to arrive at the destination; and
following the main vehicle driving route, and deciding, before reaching the congestion-prone road section, whether to switch to following the backup vehicle driving route as a substitute for the main vehicle driving route according to an actual obtained traffic condition of the congestion-prone road section.

2. The mobile navigation method according to claim 1, wherein the congestion-prone road section is designated by a user of the mobile device.

3. The mobile navigation method according to claim 1, wherein the congestion-prone road section is determined by matching one of the plurality of road sections in a database of congestion-prone road sections preset on the mobile device.

4. The mobile navigation method according to claim 1, wherein the actual obtained traffic condition of the congestion-prone road section is obtained by receiving a broadcast signal through a Traffic Message Channel (TMC) receiving module on the mobile device.

5. The mobile navigation method according to claim 1, wherein the actual obtained traffic condition of the congestion-prone road section is obtained by receiving a mobile communication signal through a radio frequency (RF) receiving module on the mobile device.

6. The mobile navigation method according to claim 1, wherein the mobile device comprises a mobile phone.

7. The mobile navigation method according to claim 1, wherein the mobile device comprises a personal digital assistant (PDA).

8. The mobile navigation method according to claim 1, wherein the mobile device comprises a personal digital assistant phone (PDA phone).

9. The mobile navigation method according to claim 1, wherein the mobile device comprises a smart phone.

10. The mobile navigation method according to claim 1, wherein the mobile device comprises a navigation device.

11. A mobile navigation device, using a Global Positioning System (GPS) module, wherein the Global Positioning System module is used to plan a main vehicle driving route according to a destination, and the main vehicle driving route comprises a plurality of road sections, and the mobile navigation device comprises:
a storage module, for storing information about at least one congestion-prone road section;
a determining unit, for determining whether or not the main vehicle driving route comprises said at least one congestion-prone road section whose information is stored in the storage module;
a receiving module, for receiving real-time broadcast messages and obtaining information about an actually congested road section accordingly; and
a route generator, for generating a backup vehicle driving route if it's determined that the main vehicle driving route comprises said at least one congestion-prone road section, and substituting the backup vehicle driving route for the main vehicle driving route if the actually congested road section matches the congestion-prone road section.

12. The mobile navigation device according to claim 11, wherein the information about an actually congested road section further comprises an actual traffic condition of the actually congested road section.

13. The mobile navigation device according to claim 12, wherein whether the backup vehicle driving route is substituted for the main vehicle driving route depends on the actual traffic condition of the actually congested road section.

14. The mobile navigation device according to claim 12, wherein the actual traffic condition of the actually congested road section is obtained by receiving a broadcast signal through a Traffic Message Channel (TMC) receiving module on the mobile device.

15. The mobile navigation device according to claim 12, wherein the actual traffic condition of the actually congested road section is obtained by receiving a mobile communication signal through a radio frequency (RF) receiving module on the mobile device.
